(19) United States
(12) Patent Application Publication
(10) Pub. No.: US 2015/0273401 A1
(43) Pub. Date: Oct. 1, 2015

(54) SELECTIVE MEMBRANE SUPPORTED ON NANOPOROUS GRAPHENE

(71) Applicant: Empire Technology Development LLC, Wilmington, DE (US)

(72) Inventors: Seth Adrian Miller, Englewood, CO (US); Gary L. Duerksen, Ward, CO (US)

(21) Appl. No.: 14/434,392

(22) PCT Filed: Nov. 30, 2012
(86) PCT No.: PCT/US12/67467

§ 371 Date: Apr. 8, 2015

(51) Int. Cl. B01D 69/12; B32B 38/00; B01D 69/14; B01D 71/06; B01D 67/00; B01D 71/02

(52) U.S. Cl. CPC B01D 69/12; B01D 67/0069; B01D 71/022; B01D 71/028; B01D 67/006; B01D 69/141; B01D 69/148; B01D 71/021; B01D 71/06; B01D 67/0062; B01D 67/0037; B32B 38/0032; B01D 2323/42

(57) ABSTRACT

Technologies are generally described for composite membranes that may include a nanoporous graphene layer sandwiched between a first selective membrane and a porous support substrate. The composite membranes may be formed by depositing the selective membrane on one side of the nanoporous graphene layer, while the other side of the nanoporous graphene layer may be supported at a nonporous support substrate. The nanoporous graphene layer may be removed with the selective membrane from the nonporous support substrate and contacted to the porous support substrate to form the composite membranes. By depositing the selective membrane on a flat surface, the nanoporous graphene on the nonporous support substrate, the selective membranes may be produced with reduced defect formation at thicknesses of as little as 0.1 μm or less. The described composite membranes may have increased permeance compared to thicker selective membranes, and structural strength greater than thin selective membranes alone.

### BACKGROUND

Unless otherwise indicated herein, the materials described in this section are not prior art to the claims in this application and are not admitted to be prior art by inclusion in this section.

A flux through membranes for gas and liquid separations generally scales inversely with membrane thickness. For example, decreasing membrane thickness by tenfold may increase the flux tenfold. However, a membrane may need to be thick enough to have sufficient mechanical strength to endure transmembrane pressures for a given separation process.

Some conventional approaches cast thin selective membranes on top of a nanoporous support, for example using solution coating. On a flat, non-porous substrate it may be possible to cast 0.05 to 0.1 micrometer thick films without pinholes. However, the manufacturing process may be very challenging for producing high quality composite membranes of 1 micrometer or less in thickness using such solution coating. Incomplete coverage of surface pores in the support membrane may lead to formation of defects, for example, because capillary forces in the porous membrane may pull the coating solution into the bulk support membrane, disrupting the coating layer. Moreover, on a porous substrate, the selective coating layer may soak into the pores, filling the pores and effectively increasing the thickness of dense material through which molecules travel.

The present disclosure appreciates that preparing thin membranes on porous supports, e.g., for use in separations, may be a complex undertaking.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present disclosure generally describes composite selective membranes supported on nanoporous graphene and methods, apparatus, and computer program products for manufacturing composite selective membranes supported on nanoporous graphene.

In various examples, composite membranes are described. The composite membranes may include a nanoporous graphene layer that has a first side and a second side. In several examples, the composite membranes may also include a first selective membrane configured in contact with the first side of the nanoporous graphene layer. In some examples, the composite membranes may further include a porous support substrate configured in contact with the second side of the nanoporous graphene layer.

In various examples, methods of preparing composite membranes are described. The methods may include depositing a first selective membrane at a second surface of a nanoporous graphene layer. In various examples, a first surface of the nanoporous graphene layer may contact a nonporous support substrate. The example methods may also include removing the nanoporous graphene layer together with the first selective membrane from the nonporous support substrate. The example methods may further include contacting the second surface of the nanoporous graphene layer to a porous support substrate to form the composite membrane.

In various examples, systems for manufacturing composite membranes are described. The systems may include one or more of: a chemical vapor deposition chamber; a chemical vapor deposition source; a heater; a temperature sensor; a graphene nano-perforation apparatus; a polymer film manipulator; a selective membrane deposition apparatus; a porous support source; and a controller. In several examples, the controller may be operatively coupled to the chemical vapor deposition chamber, the chemical vapor deposition source, the heater, the temperature sensor, the graphene nano-perforation apparatus, the polymer film manipulator, the selective membrane deposition apparatus, and the porous support source. In some examples, the controller may be configured by machine executable instructions. Instructions may also be included to control the chemical vapor deposition source, the temperature sensor, and the heater effective to deposit graphene at a nonporous growth substrate in the chemical vapor deposition chamber. Instructions may further be included to control the graphene nano-perforation apparatus effective to perforate the graphene at the nonporous growth substrate to form a nanoporous graphene layer. Instructions may be additionally be included to control the selective membrane deposition apparatus effective to deposit a first selective membrane on a first surface of the nanoporous graphene layer. Instructions may be included to control the polymer film manipulator effective to remove the nanoporous graphene layer together with the first selective membrane from a nonporous support substrate. Instructions may also be included to control the porous support source effective to provide a porous support substrate. Instructions may further be included to control the polymer film manipulator to contact a second surface of the nanoporous graphene layer to a surface of the porous support substrate effective to form the composite membrane.

In various examples, computer-readable storage media having instructions stored thereon for manufacturing composite graphene membranes are described. Instructions may be included to control a sample manipulator effective to position a nonporous support substrate in a chemical vapor deposition chamber. In several examples, a first surface of a nanoporous graphene layer may contact the nonporous support substrate. Instructions may also be included to control a selective membrane deposition apparatus effective to deposit a first selective membrane at a second surface of the nanoporous graphene layer. Instructions may further be included to control a polymer film manipulator and the sample manipulator effective to remove the nanoporous graphene layer together with the first selective membrane from the nonporous support substrate. Instructions may also be included to control the polymer film manipulator and the sample manipulator effective to contact the second surface of the nanoporous graphene layer to a porous support substrate to form the composite membrane.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments arranged in accordance with the disclosure and are, therefore, not to be considered limiting of its scope, the disclosure will be described with additional specificity and detail through use of the accompanying drawings, in which:

FIG. 1 is a conceptual side view representative of example composite membranes;

FIG. 2 is a conceptual process view representative of example techniques of constructing the described composite membranes;

FIG. 3 is a flow diagram representing example operations that may be used in various example methods of forming the described composite membrane;

FIG. 4 is a block diagram representative of automated machines that may be used for carrying out the example methods of forming the described composite membranes;

FIG. 5 is an illustration representative of general purpose computing devices that may be used to control the automated machines of FIG. 4 or similar equipment in carrying out the example methods of forming the described composite membranes; and

FIG. 6 is a block diagram representative of example computer program products that may be used to control the automated machine of FIG. 4 or similar equipment in carrying out the example methods of forming the described composite membranes; all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Briefly described, composite membranes may include a nanoporous graphene layer sandwiched between a first selective membrane and a porous support substrate. The composite membranes may be formed by depositing the selective membrane on one side of the nanoporous graphene layer, while the other side of the nanoporous graphene layer may be supported at a nonporous support substrate. The nanoporous graphene layer may be removed with the selective membrane from the nonporous support substrate and contacted to the porous support substrate to form the composite membranes. By depositing the selective membrane on a flat surface, the nanoporous graphene on the nonporous support substrate, the selective membranes may be produced with reduced defect formation at thicknesses of as little as 0.1 μm or less. The described composite membranes may have increased permeance compared to thicker selective membranes, and structural strength greater than thin selective membranes alone.

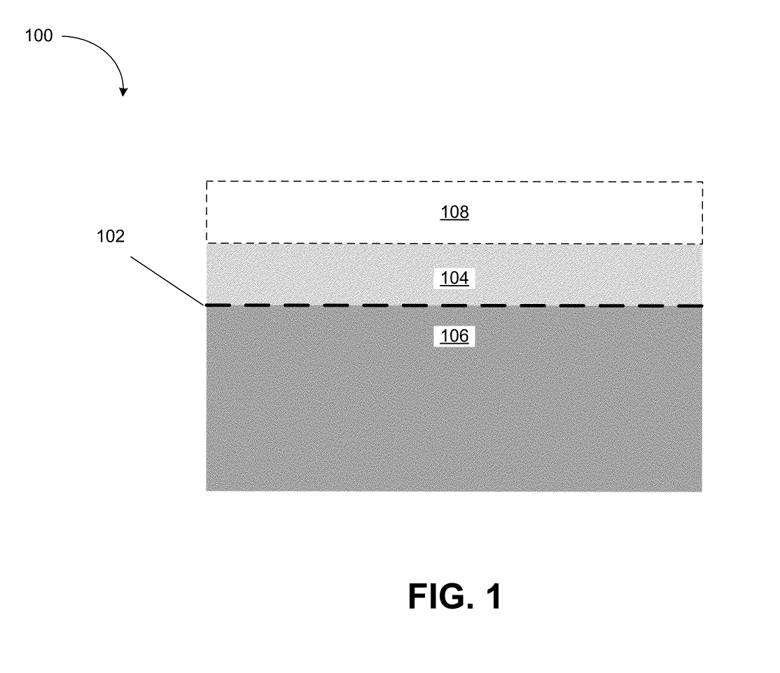

FIG. 1 is a conceptual side view representative of example composite membranes, arranged in accordance with at least some embodiments described herein. For example, a composite membrane 100 may include a nanoporous graphene layer 102 that has a first side and a second side. The composite membrane 100 may also include a first selective membrane 104 configured in contact with the first side of the nanoporous graphene layer 102. The composite membrane may further include a porous support substrate 106 configured in contact with the second side of the nanoporous graphene layer. In several examples, the composite membrane 100 may optionally be configured to include a second selective membrane 108 configured in contact with the first selective membrane 104 opposite the nanoporous graphene layer 102.

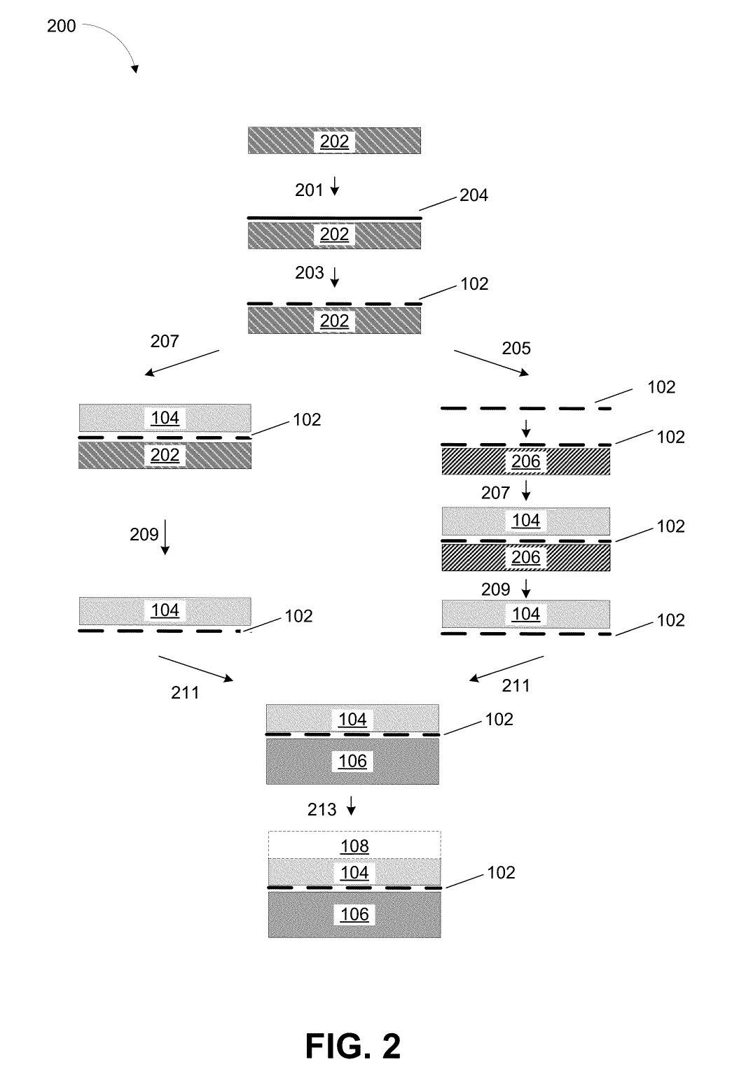

FIG. 2 is a conceptual process view representative of example techniques of constructing the described composite membranes, arranged in accordance with at least some embodiments described herein. For example, a process 200 may include 201 growing a monolayer or more of graphene 204 at a nonporous growth substrate 202 and 203 perforating the graphene 204 to form the nanoporous graphene layer 102. The technique 200 may optionally include 205 transferring the nanoporous graphene layer 102 to a nonporous support substrate 206, for example, in cases where the nonporous growth substrate 202 may be chemically incompatible with a subsequent operation. The technique 200 may include 207 depositing the first selective membrane 104 at the nanoporous graphene layer 102, at either the nonporous growth substrate 202 or the nonporous support substrate 206. The combined first selective membrane 104 supported on the nanoporous graphene layer 102 may be 209 removed from the nonporous growth substrate 202 or the nonporous support substrate 206. The combined first selective membrane 104 supported on the nanoporous graphene layer 102 may then be 211 contacted to a porous support substrate 106. At any point after formation of the first selective membrane 104, the second selective membrane 108 may be optionally 213 applied to the first selective membrane 104.

The monolayer or more of graphene 204 may be grown by standard chemical vapor deposition (CVD) processes for growing graphene. The nonporous substrate 202 may be substantially planar or atomically flat. The nonporous substrate 202 may include any variety of substrates suitable for growing graphene via chemical vapor deposition. Suitable materials for substrate 202 may include transition metals, especially, for example, copper foils, nickel foils, alloys, and combinations thereof. The transition metals may also be supplied as a thin metal coating on a substantially flat or atomically flat support. The support for the metal coating may be, for example, quartz, silicon, or the like. In some examples, the metal coating may have a thickness in a range of between about 1 atomic monolayer and about 25 micrometers.

The graphene layer 204 may be perforated to form the nanoporous graphene layer 102 using any suitable technique for perforating graphene, for example, using electron beam etching, ion beam etching, atomic abstraction, colloidal lithography, block copolymer lithography, or photolithography. The nanoporous graphene layer 102 may be a nanoporous graphene monolayer or may include multiple nanoporous graphene layers, e.g., between about 2 and about 10 graphene monolayers. The nanoporous graphene layer 102 may include pores characterized by an average diameter in a range between about 2 angstroms and about 1 micrometer.

In various examples, the nanoporous graphene layer 102 may be moved from the nonporous growth substrate 202 to the nonporous support substrate 206, for example, using a roll to roll process, a contact lifting process, a contact printing/deposition process or another suitable process for moving the nanoporous graphene layer 102.

The first and second selective membranes 104 and 108 may be deposited by any suitable technique for depositing the material of the corresponding selective membrane. For example, the first and second selective membranes 104 and 108 may be independently applied by solution deposition, electro-deposition, spin coating, dip coating, chemical growth deposition, polymerization, precipitation, chemical vapor deposition, atomic layer deposition, sputtering, or evaporative deposition.

During formation of thin selective membranes, voids on a casting substrate and related capillary forces may act to draw a precursor of the thin selective membrane into the voids, which may result in defect formation, such as pinholes or other defects. Such defect formation may otherwise make it challenging or impractical to form selective membranes at thicknesses approaching 1 micrometer, or below 1 micrometer.

In various examples, technique 200 may feature growing the first selective membrane 104 on top of the nanoporous graphene layer 102 while the nanoporous graphene layer 102 may be attached to the nonporous growth substrate 204 or the nonporous support substrate 206. The nanoporous graphene layer 102 may present a substantially two-dimensional surface structure because the nanoporous graphene layer 102 may be only one or a few graphene monolayers deep. Thus, the nanoporous graphene layer 102 at the nonporous growth substrate 204 or the nonporous support substrate 206 may be substantially without voids. Because the nanoporous graphene layer 102 at the nonporous growth substrate 204 or the nonporous support substrate 206 may be substantially without voids, the nanoporous graphene layer 102 may be substantially free from capillary forces when in contact with a precursor of the first selective membrane, e.g., a polymer casting solution. The technique 200 may be able to prepare the first selective membrane 104 with fewer defects and/or in thinner layers than may otherwise be possible. In various examples, the technique 200 may feature preparing the selective membrane 104 at a thickness of less than about 1 micrometer, in some examples less than about 0.1 micrometers. Reducing the thickness of the selective membranes described herein may increase corresponding membrane permeance substantially in comparison to thicker selective membranes.

The first and second selective membranes 104 and 108 may include any thin selective membrane, for example, polymer films, selective inorganic membranes such as zeolites, ceramics, or metals, or combined selective porous materials such as metal organic frameworks.

For example, suitable polymers for the first and second selective membranes 104 and 108 may include: an acrylonitrile-butadiene-styrene, an allyl resin, a carbon fiber, a cellulosic resin, an epoxy, a polyalkylene vinyl alcohol, a fluoropolymer, a melamine formaldehyde resin, a phenol-formaldehyde resin, a polyacetal, a polyacrylate, a polyacrylonitrile, a polyacrylonitrile, a polyalkylene, a polyalkylene carbamate, a polyalkylene oxide, a polyalkylene sulphide, a polyalkylene terephthalate, a polyalkyl alkylacrylate, a polyalkyleneamide, a halopolyalkylene, a polyamide, a polyamide-imide, a polyarylene isophthalamide, a polyarylene oxide, a polyarylene sulfide, a polyaramide, a polyarylene terephthalamide, a polyaryletherketone, a polycarbonate, a polybutadiene, a polyketone, a polyester, a polyetheretherketone, a polyetherimide, a polyethersulfone, a polyimide, a polyphthalamide, a polystyrene, a polysulfone, a polytetrafluoroalkylene, a polyurethane, a polyvinyl alkyl ether, a polyvinylhalide, a polyvinylidene halide, a silicone polymer, or a combination or a copolymer thereof.

Suitable zeolites for first and second selective membranes 104 and 108 may include, for example: synthetic mordenite or synthetic ferrierite; synthetic aluminosilicate or silicate zeolites such as Linde Type A (LTA), Linde Types X and Y (Al-rich and Si-rich FAU), Silicalite-1, ZSM-5, ZSM-11, etc. (MFI), Linde Type B (zeolite P) (GIS), Beta (BEA), Linde Type F (EDI), Linde Type L (LTL), Linde Type W (MER), and SSZ-32 (MTT); nonaluminosilicate, synthetic molecular sieves such as aluminophosphates (AlPO₄ structures); silicoaluminophosphates (SAPO family); various metal-substituted aluminophosphates [MeAPO family, such as CoAPO-50 (AFY); and crystalline silicotitanates. Examples of synthetic zeolites and representative formulae include, e.g.: A zeolites, e.g., Na₂O.Al₂O₃.₂SiO₂.4,5H₂O; N-A zeolites, e.g., (Na, TMA)₂O. Al₂O₃.4.8SiO₂.7H₂O TMA-(CH₃)4N+; H zeolites, e.g., K₂O.Al₂O₃.₂SiO₂.4H₂O; L zeolites, e.g., (K₂Na₂)O.Al₂O₃.6SiO₂.5H₂O; X zeolites, e.g., Na₂O.Al₂O₃.₂,5SiO₂.6H₂O; Y zeolites, e.g., Na₂O.Al₂O₃.4.8SiO₂.8,9H₂O; P zeolites, e.g., Na₂O.Al₂O₃.₂-5SiO₂.5H₂O; O zeolites, e.g., (Na₂,K₂,TMA₂)0.Al₂O₃.7SiO₂.₃,5H₂O;TMA-(CH₃)4N+; Ωzeolites, e.g., (Na,TMA)₂O.Al₂O₃.7SiO₂.5H₂O; TMA-(CH₃)4N+; and ZK-4 zeolites, e.g., 0.85Na₂O.0.15 (TMA)₂O. Al₂O₃.₃,₃SiO₂.6H₂O.

Suitable metals for the first and second selective membranes 104 and 108 may include, for example, permeable films of metals or alloys thereof which may include, e.g., Mg, Al, Ca, Sc, Ti, V, Cr, Mn, Fe, Co, Ni, Cu, Zn, Rb, Sr, Y, Zr, Nb, Mo, Tc, Ru, Rh, Pd, Pt, Ag, Cd, In, or Sn.

Suitable metal organic frameworks for the first and second selective membranes 104 and 108 may include polydentate organic ligand salts or complexes of metals, such as transition metals. Examples of polydentate organic ligands suitable for metal organic frameworks may include, but are not limited to compounds such as: bidentate carboxylics, e.g., ethanedioic acid, propanedioic acid, butanedioic acid, pentanedioic acid, phthalic acid, benzene-1,2-dicarboxylic acid, o-phthalic acid, isophthalic acid, benzene-1,3-dicarboxylic acid, m-phthalic acid, terephthalic acid, benzene-1,4-dicarboxylic acid, or p-phthalic acid; tridentate carboxylates, e.g., 2-hydroxy-1,2,3-propanetricarboxylic acid or benzene-1,3,5-tricarboxylic acid; azoles, e.g., 1,2,3-triazole or pyrrodiazole; or other polydentate ligands, e.g., squaric acid. Examples of metal atoms suitable for forming metal organic frameworks with polydentate organic ligands may include, but are not limited to metals and ions thereof such as Mg, Al, Ca, Sc, Ti, V, Cr, Mn, Fe, Co, Ni, Cu, Zn, Rb, Sr, Y, Zr, Nb, Mo, Tc, Ru, Rh, Pd, Ag, Cd, In, or Sn.

Suitable materials for the nonporous support substrate 206 may be selected based on the chemical or physical compatibility with a subsequent operation. For example, many zeolite deposition processes may be chemically reactive or otherwise incompatible with a metal as a nonporous growth substrate 202, such as copper. Suitable nonporous support substrates 206 may include, for example, glass; quartz; ceramics; silicon; or polymers such as polytetrafluoroethylene, polyoxymethylene, polyoxyethylene, polyethylene, or polypropylene.

The porous support substrate 106 may function to mechanically support the first selective membrane 104 and the nanoporous graphene layer 102. The porous support substrate 106 may include woven fibrous membranes, nonwoven fibrous membranes, porous polymer membranes, porous ceramic membranes, a porous metal foam, or a metal mesh or screen. The porous support substrate may include pores characterized by an average diameter in a range between about 1 micrometer and about 1 millimeter. Suitable materials for the porous support substrate 106 include: porous polymer sheets, such as polysulfone, or expanded polytetrafluoroethylene (e.g., GORE-TEX®, Newark, Del.) metal meshes such as stainless steel, or non-woven dense fabrics (e.g., T-191 polypropylene fiber fabric, FIBERVISIONS®, Covington, Ga.).

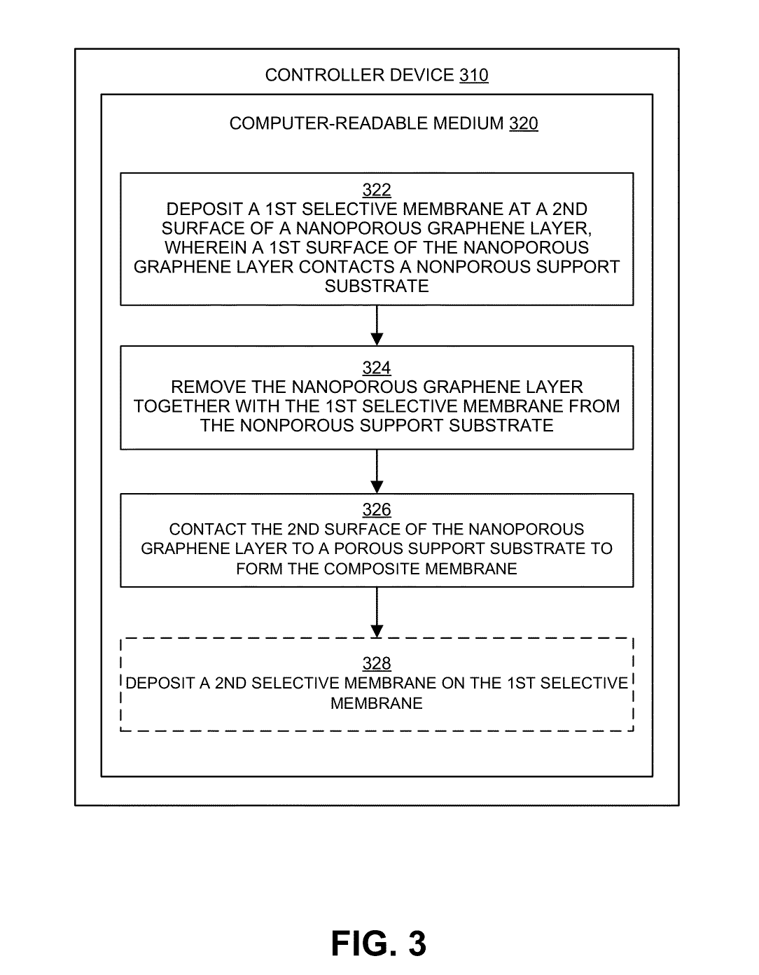

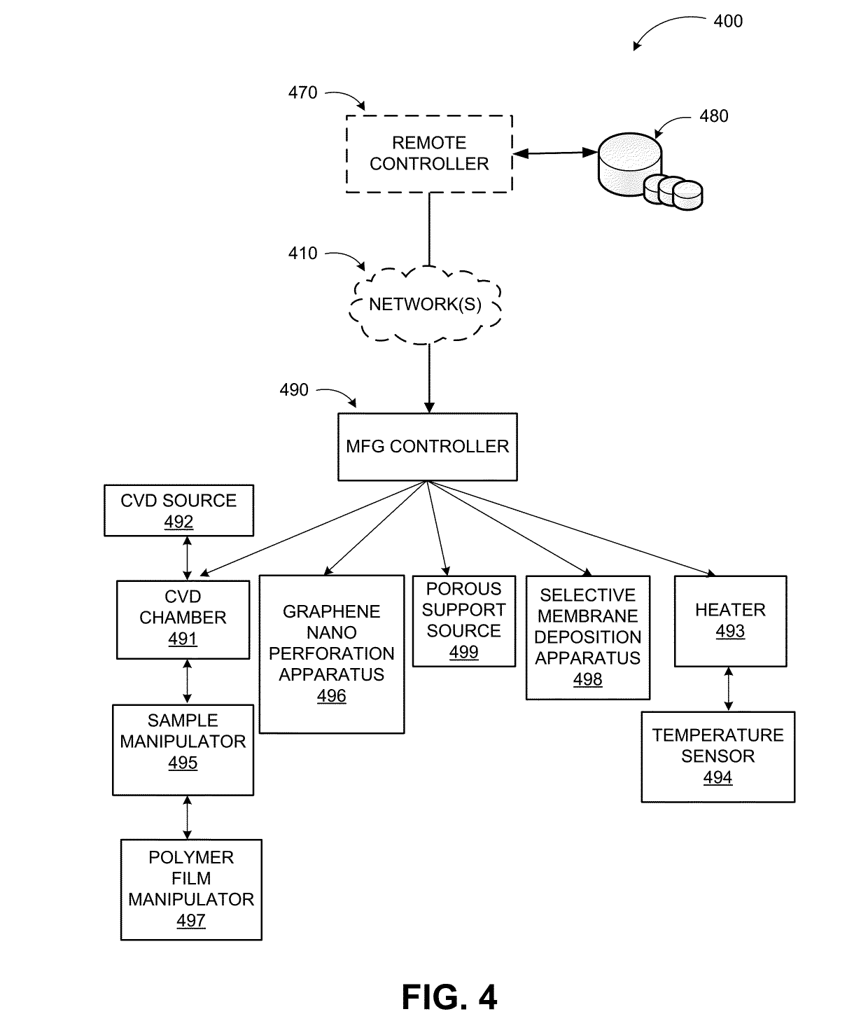

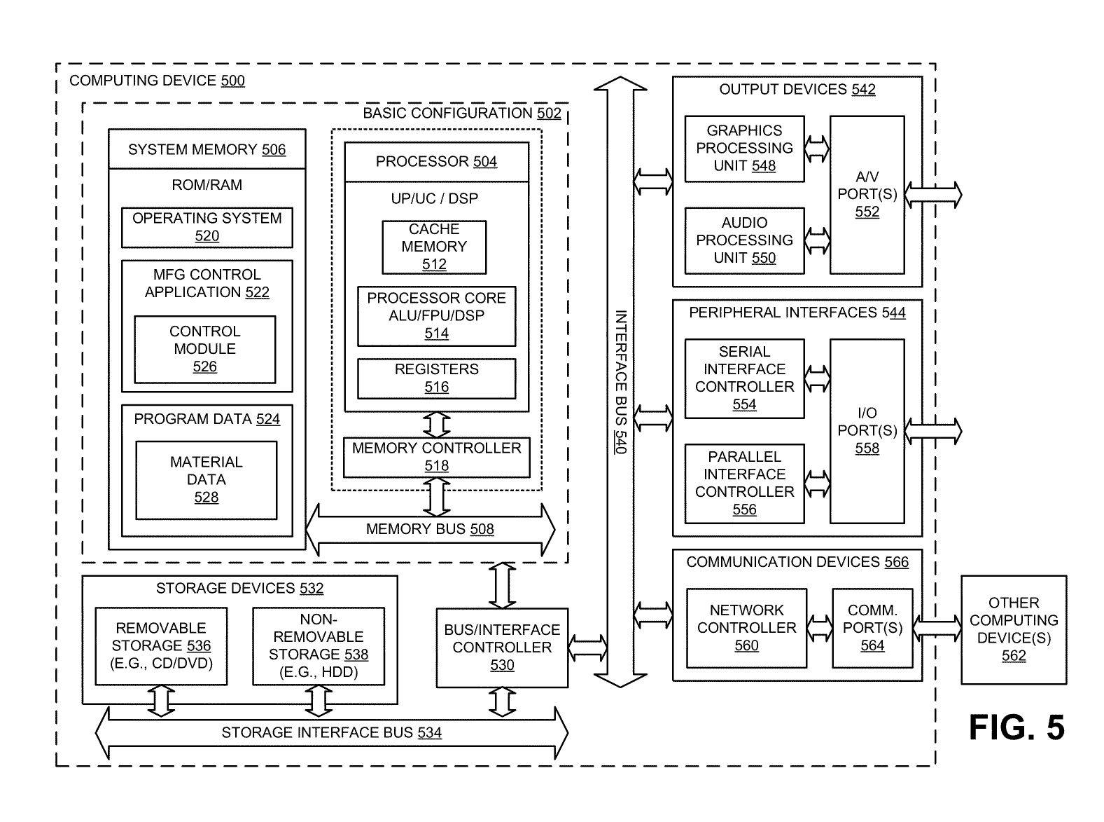

FIG. 3 is a flow diagram representing example operations that may be used in various example methods of forming the described composite membrane, arranged in accordance with at least some embodiments described herein. A process of manufacturing the composite membranes as described herein may include one or more operations, functions, techniques, or actions as may be illustrated by one or more of operations 322, 324, and/or 326. Example methods of manufacturing the composite membranes as described herein may be operated by a controller device 310, which may be embodied as computing device 500 in FIG. 5 or a special purpose controller such as manufacturing controller 490 of FIG. 4, or similar devices configured to execute instructions stored in computer-readable medium 320 for controlling the performance of the example methods.

Some example processes may begin with operation 322 “DEPOSIT A 1ST SELECTIVE MEMBRANE AT A 2ND SURFACE OF A NANOPOROUS GRAPHENE LAYER, WHEREIN A 1ST SURFACE OF THE NANOPOROUS GRAPHENE LAYER CONTACTS A NONPOROUS SUPPORT SUBSTRATE.” Operation 322 may include any technique of forming the described selective membranes as described herein, for example, by applying a fluid suspension of colloid particles to the graphene monolayer by dip coating, spin coating, spray coating, or curtain coating.

Operation 322 may be followed by operation 324, “REMOVE THE NANOPOROUS GRAPHENE LAYER TOGETHER WITH THE 1ST SELECTIVE MEMBRANE FROM THE NONPOROUS SUPPORT SUBSTRATE.” Operation 324 may be conducted by any technique described herein, for example, using a roll to roll process, a contact lifting process, a contact printing/deposition process, dry stamping, or another suitable process for removing the nanoporous graphene layer 102 together with the first selective membrane 104.

Operation 324 may be followed by operation 326, “CONTACT THE 2ND SURFACE OF THE NANOPOROUS GRAPHENE LAYER TO A POROUS SUPPORT SUBSTRATE TO FORM THE COMPOSITE MEMBRANE.” Operations 324 and 326 may be separately or jointly conducted by any technique described herein, for example, using a roll to roll process, a contact lifting process, a contact printing/deposition process, dry stamping, or another suitable process for moving the nanoporous graphene layer 102 together with the first selective membrane 104.

Any of operations 322, 324, or 326 may be followed by optional operation 328, “DEPOSIT A 2ND SELECTIVE MEMBRANE ON THE 1^{ST} SELECTIVE MEMBRANE.” Operation 328 may be conducted by any technique described herein for forming the second selective membrane 108, for example, solution deposition, electro-deposition, spin coating, dip coating, chemical growth deposition, polymerization, precipitation, chemical vapor deposition, atomic layer deposition, sputtering, or evaporative deposition.

The operations included in the process of FIG. 3 described above are for illustration purposes. A process of manufacturing the composite membranes as described herein may include may be implemented by similar processes with fewer or additional operations. In some examples, the operations may be performed in a different order. In some other examples, various operations may be eliminated. In still other examples, various operations may be divided into additional operations, or combined together into fewer operations. Although illustrated as sequentially ordered operations, in some implementations the various operations may be performed in a different order, or in some cases various operations may be performed at substantially the same time. For example, any other similar process may be implemented with fewer, different, or additional operations so long as such similar processes form the composite membranes as described herein.

FIG. 4 is a block diagram representative of automated machines that may be used for carrying out the example methods of forming the described composite membranes, in accordance with at least some embodiments described herein. For example, automated machine 400 may be operated as described herein using the process operations outlined in FIG. 3.

As illustrated in FIG. 4, a manufacturing controller 490 may be coupled to the machines that may be employed to carry out the operations described in FIG. 3, for example: a chemical vapor deposition chamber 491; a chemical vapor deposition source 492; a heater 493; a temperature sensor 494; a sample manipulator 495; a graphene nano-perforation apparatus 496; a polymer film manipulator 497; a selective membrane deposition apparatus 498; a porous support source 499.

Manufacturing controller 490 may be operated by human control, by a remote controller 470 via one or more network(s) 410, or by machine executed instructions such as might be found in a computer program. Data associated with controlling the different processes of manufacturing graphene may be stored at and/or received from data stores 480. Further, the individual elements of manufacturing system 400 may be implemented as any suitable device configured in any suitable fashion for carrying out the operations described herein.

For example, sample manipulator 495 may be stationary or may include one or more moving functions, such as translation in zero, one, two, or 3 perpendicular axes, rotation in one, two, or 3 perpendicular axes, or combinations thereof. Such moving functions may be provided by motors, linear actuators, or piezoelectric actuators. Such moving functions may be provided in combination with moving functions for other elements of manufacturing system 400. For example, for CVD growth of graphene at a nonporous substrate, either or both of sample manipulator 495 and CVD source 492 may be moved relative to each other at CVD chamber 192 to grow graphene at a nonporous substrate. Likewise, graphene nano-perforation apparatus 496 may be configured for any technique of forming the nanopores in the graphene. Further, sample manipulator 495 and polymer film manipulator 497 may be configured for any approach for removing the nanoporous graphene layer together with the first selective membrane from the nonporous support substrate. Also, selective membrane deposition apparatus 498 may be configured for any approach for depositing the first selective membrane at the second surface of the nanoporous graphene layer.

The apparatus elements described above for FIG. 4 are for illustration purposes. An apparatus for forming the described composite membranes as described herein may be implemented by similar apparatus with fewer or additional elements. In some examples, the apparatus elements may be configured locations or in different order. In some other examples, various apparatus elements may be eliminated. In still other examples, various apparatus elements may be divided into additional apparatus elements, or combined together into fewer apparatus elements. Any other similar automated machine may be implemented with fewer, different, or additional apparatus elements so long as such similar automated machines form the described composite membranes.

FIG. 5 is an illustration representative of general purpose computing devices that may be used to control the automated machines of FIG. 4 or similar equipment in carrying out the example methods of forming the described composite membranes, arranged, arranged in accordance with at least some embodiments described herein. In a basic configuration 502, referring to the components within the dashed line, computing device 500 typically may include one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level cache memory 512, a processor core 514, and registers 516. Processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more manufacturing control applications 522, and program data 524. Manufacturing control application 522 may include a control module 526 that may be arranged to control manufacturing system 400 of FIG. 4 and any other processes, operations, techniques, methods, and functions as discussed above. Program data 524 may include, among other data, material data 528 for controlling various aspects of the manufacturing system 400.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices may include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any technique or technology for storage of information, such as computer readable instructions, data structures, program modules, or other data.

System memory 506, removable storage devices 536 and non-removable storage devices 538 may be examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 566 to basic configuration 502 via bus/interface controller 530. Output devices 542 may include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. A communication device 566 may include a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a physical server, virtual server, a computing cloud, or a hybrid device that include any of the above functions. Computing device 500 may also be implemented as a personal computer including both laptop computer and non-laptop computer configurations. Moreover computing device 500 may be implemented as a networked system or as part of a general purpose or specialized server.

Networks for a networked system including computing device 500 may include any topology of servers, clients, switches, routers, modems, Internet service providers, and any appropriate communication media (e.g., wired or wireless communications). A system according to embodiments may have a static or dynamic network topology. The networks may include a secure network such as an enterprise network (e.g., a LAN, WAN, or WLAN), an unsecure network such as a wireless open network (e.g., IEEE 602.11 wireless networks), or a world-wide network such (e.g., the Internet). The networks may also include multiple distinct networks that may be adapted to operate together. Such networks may be configured to provide communication between the nodes described herein. By way of example, and not limitation, these networks may include wireless media such as acoustic, RF, infrared and other wireless media. Furthermore, the networks may be portions of the same network or separate networks.

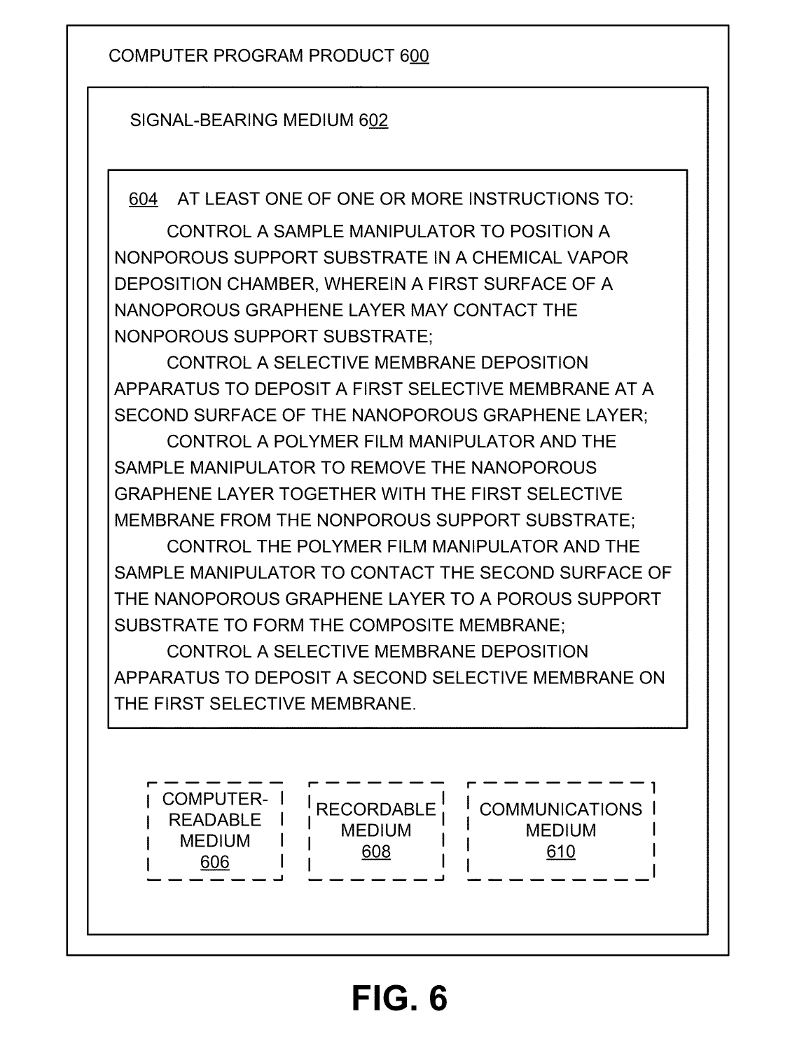

FIG. 6 is a block diagram representative of example computer program products that may be used to control the automated machine of FIG. 4 or similar equipment in carrying out the example methods of forming the described composite membranes, arranged in accordance with at least some embodiments described herein. In some examples, as shown in FIG. 6, computer program product 600 may include a signal bearing medium 602 that may also include machine readable instructions 604 that, when executed by, for example, a processor, may provide the functionality described above with respect to FIG. 3 through FIG. 5. For example, referring to manufacturing controller 490, one or more of the tasks shown in FIG. 6 may be undertaken in response to machine readable instructions 604 conveyed to the imaging controller 490 by signal bearing medium 602 to perform actions associated with forming the composite membranes as described herein. Some of those instructions may include, for example, one or more instructions to: “control a sample manipulator to position a nonporous support substrate in a chemical vapor deposition chamber, wherein a first surface of a nanoporous graphene layer may contact the nonporous support substrate;” “control a selective membrane deposition apparatus to deposit a first selective membrane at a second surface of the nanoporous graphene layer;” “control a polymer film manipulator and the sample manipulator to remove the nanoporous graphene layer together with the first selective membrane from the nonporous support substrate;” “control the polymer film manipulator and the sample manipulator to contact the second surface of the nanoporous graphene layer to a porous support substrate to form the composite membrane;” or “control the selective membrane deposition apparatus to deposit a second selective membrane on the first selective membrane.”

In some implementations, signal bearing medium 602 depicted in FIG. 6 may encompass a computer-readable medium 606, such as, but not limited to, a hard disk drive, a Compact Disc (CD), a Digital Versatile Disk (DVD), a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). For example, computer program product 600 may be conveyed to the processor 504 by an RF signal bearing medium 602, where the signal bearing medium 602 may be conveyed by a communications medium 610 (e.g., a wireless communications medium conforming with the IEEE 802.11 standard).While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks may be performed by remote processing devices that may be linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that may include instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing a configuration environment, which may facilitate configuration of software/hardware products and services for a variety of purposes. Examples of platforms include, but are not limited to, a hosted service executed over multiple servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is described below.

### EXAMPLES

### Example 1

The first selective membrane 104 may be prepared from a polymer, for example, a poly(ethylene oxide)-block-poly(ethylene(oxide)-poly(butylene terephthalate) multi-block copolymer (IsoTis OrthoBiologics, Irvine, Calif.). The multi-block copolymer may be dissolved in chloroform or tetrahydrofuran at about 0.1% to 0.2% by weight to form a multi-block copolymer solution. The multi-block copolymer solution may be spread onto a sample of the nanoporous graphene layer 102 using a Meyer rod to create a uniform film. The solvent may be allowed to dry in air to form a film of the multi-block copolymer less than one micrometer thick at the nanoporous graphene layer 102.

### Example 2

The first selective membrane 104 may be prepared by depositing a mixed precursor film of about 90-99% poly(ethylene glycol) monomethyl ether acrylate, and about 1-10% poly(ethylene gycol) diacrylate, with about 0.1% 2,4-diethyl-9H-thioxanthen-9-one as a photoinitiator. The mixed precursor film may be dried, and may be cured for 5 minutes using 365 nanometer light to form the first selective membrane 104 as a crosslinked film less than one micrometer thick at the nanoporous graphene layer 102. After the first selective membrane 104 has dried and cured, the composite of the first selective membrane 104 and the nanoporous graphene layer 102 may be lifted from the substrate using standard lift-off methods (dry or wet), and may then be transferred to a two-or three dimensional mechanical support, such as a metal mesh.

### Example 3

The first selective membrane 104 may be prepared as a zeolite film, such as ZSM-5. The nanoporous graphene layer 102 may be grown on copper foil and may be transferred to a nonporous support substrate 206 configured as polytetrafluoroethylene, as the copper foil may otherwise corrode during zeolite crystallization. A seed layer of zeolites may be produced by hydrothermal growth at about 130° C. for about 12 hours in a mixture with a molar composition of 5SiO₂:1TPAOH:500H₂O:20EtOH, and calcined at about 520° C. The ZSM-5 seeds may be cast on the patterned graphene layer by dip coating. Zeolite crystals may be grown using the above conditions for about 20 hours to coat the nanoporous graphene layer 102 with the first selective membrane 104 as a film of zeolite ZSM-5. The composite of the first selective membrane 104 and the nanoporous graphene layer 102 may be lifted from the polytetrafluoroethylene substrate and transferred using dry stamping to a two-or three dimensional mechanical support, such as a metal mesh.

### Example 4

Dense selective membranes such at the polyethylene oxide block copolymer of Example 1 may be especially useful in carbon dioxide separations. Carbon dioxide membranes may be used, for example, to sweeten natural gas streams, which may include “reverse selectivity” for selectively separating larger carbon dioxide molecules from a stream of smaller methane molecules. The composite membrane of Example 1 may be contacted to a relatively CO₂-poor gas stream pressurized upstream of the composite membrane, and a relatively CO₂-rich gas stream permeating through at a reduced pressure downstream of the composite membrane. Because of the great tensile strength of graphene, high transmembrane pressures (e.g., greater than about 10-100 atmospheres) may be applied to the composite membrane even when the size of the pores in the mechanical support may be exceptionally large (e.g., greater than about 100 micrometers in diameter).

In various examples, a composite membrane is described. The composite membrane may include a nanoporous graphene layer that has a first side and a second side. The composite membrane may also include a first selective membrane configured in contact with the first side of the nanoporous graphene layer. The composite membrane may further include a porous support substrate configured in contact with the second side of the nanoporous graphene layer.

In some examples of the composite membrane, the first selective membrane may include one or more of: a polymer, a zeolite, a metal, a metal-organic framework, or a ceramic. The first selective membrane may include one or more of: an acrylonitrile-butadiene-styrene, an allyl resin, a carbon fiber, a cellulosic resin, an epoxy, a polyalkylene vinyl alcohol, a fluoropolymer, a melamine formaldehyde resin, a phenol-formaldehyde resin, a polyacetal, a polyacrylate, a polyacrylonitrile, a polyacrylonitrile, a polyalkylene, a polyalkylene carbamate, a polyalkylene oxide, a polyalkylene sulphide, a polyalkylene terephthalate, a polyalkyl alkylacrylate, a polyalkyleneamide, a halopolyalkylene, a polyamide, a polyamide-imide, a polyarylene isophthalamide, a polyarylene oxide, a polyarylene sulfide, a polyaramide, a polyarylene terephthalamide, a polyaryletherketone, a polycarbonate, a polybutadiene, a polyketone, a polyester, a polyetheretherketone, a polyetherimide, a polyethersulfone, a polyimide, a polyphthalamide, a polystyrene, a polysulfone, a polytetrafluoroalkylene, a polyurethane, a polyvinyl alkyl ether, a polyvinylhalide, a polyvinylidene halide, a silicone polymer, or a combination or a copolymer thereof. The first selective membrane may be characterized by an average thickness in a range between about 10 nanometers to about 1 micrometer.

In some examples of the composite membrane, the porous support substrate may include one or more of: a woven fibrous membrane, a nonwoven fibrous membrane, a porous polymer membrane, a porous ceramic membrane, a porous metal foam, or a metal mesh. The porous support substrate may include a plurality of pores characterized by an average diameter in a range between about 1 micrometer and about 1 millimeter. The nanoporous graphene layer may be a nanoporous graphene monolayer. The nanoporous graphene layer may also include a plurality of pores characterized by an average diameter in a range between about 2 angstroms and about 1 micrometer.

In several examples, the composite membrane may also include a second selective membrane configured in contact with the first selective membrane. At least one of the first selective membrane and the second selective membrane may be characterized by an average thickness of less than about 1 micrometer.

In various examples, a method of preparing a composite membrane is described. The method may include depositing a first selective membrane at a second surface of a nanoporous graphene layer. A first surface of the nanoporous graphene layer may contact a nonporous support substrate. The method may also include removing the nanoporous graphene layer together with the first selective membrane from the nonporous support substrate. The method may further include contacting the second surface of the nanoporous graphene layer to a porous support substrate effective to form the composite membrane.

In some examples, the method may include growing graphene at a nonporous growth substrate. The method may also include perforating the graphene to form the nanoporous graphene layer. Perforating the graphene to form the nanoporous graphene layer may include one or more of: electron beam etching, ion beam etching, atomic abstraction, colloidal lithography, block copolymer lithography, or photolithography. The method may also include transferring the nanoporous graphene layer from the nonporous growth substrate to the nonporous support substrate. The nonporous growth substrate may be the nonporous support substrate.

Several examples of the method may further include selecting the nanoporous graphene layer including a nanoporous graphene monolayer. The method may also include selecting the nanoporous graphene layer including a plurality of pores characterized by an average diameter in a range between about 2 angstroms and about 1 micrometer. Depositing the first selective membrane may include one or more of: solution deposition, electro-deposition, spin coating, dip coating, chemical growth deposition, polymerization, precipitation, chemical vapor deposition, atomic layer deposition, sputtering, or evaporative deposition. The method may include selecting the first selective membrane including one or more of: a polymer, a zeolite, a metal, a metal-organic framework, and/or a ceramic. The first selective membrane may include one or more of: an acrylonitrile-butadiene-styrene, an allyl resin, a carbon fiber, a cellulosic resin, an epoxy, a polyalkylene vinyl alcohol, a fluoropolymer, a melamine formaldehyde resin, a phenol-formaldehyde resin, a polyacetal, a polyacrylate, a polyacrylonitrile, a polyacrylonitrile, a polyalkylene, a polyalkylene carbamate, a polyalkylene oxide, a polyalkylene sulphide, a polyalkylene terephthalate, a polyalkyl alkylacrylate, a polyalkyleneamide, a halopolyalkylene, a polyamide, a polyamide-imide, a polyarylene isophthalamide, a polyarylene oxide, a polyarylene sulfide, a polyaramide, a polyarylene terephthalamide, a polyaryletherketone, a polycarbonate, a polybutadiene, a polyketone, a polyester, a polyetheretherketone, a polyetherimide, a polyethersulfone, a polyimide, a polyphthalamide, a polystyrene, a polysulfone, a polytetrafluoroalkylene, a polyurethane, a polyvinyl alkyl ether, a polyvinylhalide, a polyvinylidene halide, a silicone polymer, or a combination or a copolymer thereof.

In various examples of the method, depositing the first selective membrane may include depositing in an average thickness in a range between about 10 nanometers and about 1 micrometer. The method may include selecting the porous support substrate including one or more of: a woven fibrous membrane, a nonwoven fibrous membrane, a porous polymer membrane, a porous ceramic membrane, a porous metal foam, or a metal mesh. The method may include selecting the porous support substrate including a plurality of pores characterized by an average diameter in a range between about 1 micrometer and about 1 millimeter. The method may further include contacting a second selective membrane to the first selective membrane, wherein at least one of the first selective membrane and the second selective membrane may be characterized by an average thickness of less than about 1 micrometer.

In various examples, a system for manufacturing a composite membrane is described. The system may include one or more of: a chemical vapor deposition chamber; a chemical vapor deposition source; a heater; a temperature sensor; a sample manipulator; a graphene nano-perforation apparatus; a polymer film manipulator; a selective membrane deposition apparatus; a porous support source; and a controller. The controller may be operatively coupled to the chemical vapor deposition chamber, the chemical vapor deposition source, the heater, the temperature sensor, the sample manipulator, the graphene nano-perforation apparatus, the polymer film manipulator, the selective membrane deposition apparatus, and the porous support source. The controller may be configured by machine executable instructions. Instructions may be included to control the sample manipulator effective to position a nonporous growth substrate in the chemical vapor deposition chamber. Instructions may also be included to control the chemical vapor deposition source, the temperature sensor, and the heater effective to deposit graphene at the nonporous growth substrate in the chemical vapor deposition chamber. Instructions may further be included to control the graphene nano-perforation apparatus effective to perforate the graphene at the nonporous growth substrate to form a nanoporous graphene layer. Instructions may be additionally be included to control the selective membrane deposition apparatus effective to deposit a first selective membrane on a first surface of the nanoporous graphene layer. Instructions may be included to control the polymer film manipulator effective to remove the nanoporous graphene layer together with the first selective membrane from a nonporous support substrate. Instructions may also be included to control the porous support source effective to provide a porous support substrate. Instructions may further be included to control the polymer film manipulator effective to contact a second surface of the nanoporous graphene layer to a surface of the porous support substrate to form the composite membrane.

In some examples of the system, the controller may be further configured by the executable instructions to control the polymer film manipulator effective to transfer the nanoporous graphene layer from the nonporous growth substrate to the nonporous support substrate prior to deposition of the first selective membrane on the first surface of the nanoporous graphene layer. Instructions may be included to control the graphene nano-perforation apparatus effective to perforate the graphene using one or more of: electron beam etching, ion beam etching, atomic abstraction, colloidal lithography, block copolymer lithography, or photolithography. Instructions may also be included to control the chemical vapor deposition source, the temperature sensor, and the heater effective to deposit the graphene at the nonporous growth substrate as a graphene monolayer. Instructions may further be included to control the selective membrane deposition apparatus effective to deposit the first selective membrane by one or more of: solution deposition, electro-deposition, spin coating, dip coating, chemical growth deposition, polymerization, precipitation, chemical vapor deposition, atomic layer deposition, sputtering, or evaporative deposition.

In several examples of the system, instructions may be included to control the selective membrane deposition apparatus effective to deposit the first selective membrane in an average thickness in a range between about 10 nanometers and about 1 micrometer. Instructions may be included to control the polymer film manipulator to contact a second selective membrane to the first selective membrane. At least one of the first selective membrane and the second selective membrane may be characterized by an average thickness of less than about 1 micrometer.

In various examples, computer-readable storage media having instructions stored thereon for manufacturing a composite graphene membrane are described. Instructions may be included to control a sample manipulator effective to position a nonporous support substrate in a chemical vapor deposition chamber. A first surface of a nanoporous graphene layer may contact the nonporous support substrate. Instructions may also be included to control a selective membrane deposition apparatus effective to deposit a first selective membrane at a second surface of the nanoporous graphene layer. Instructions may further be included to control a polymer film manipulator and the sample manipulator effective to remove the nanoporous graphene layer together with the first selective membrane from the nonporous support substrate. Instructions may also be included to control the polymer film manipulator and the sample manipulator effective to contact the second surface of the nanoporous graphene layer to a porous support substrate to form the composite membrane.

In some examples of the computer readable storage media, instructions may be included to control a chemical vapor deposition source, a temperature sensor, and a heater to deposit graphene at the nonporous growth substrate in the chemical vapor deposition chamber. Instructions may also be included to control a graphene nano-perforation apparatus effective to perforate the graphene at the nonporous growth substrate to form the nanoporous graphene layer. Instructions may further be included to control the chemical vapor deposition source, the temperature sensor, and the heater effective to deposit the graphene as a monolayer at the nonporous growth substrate. Instructions may also be included to control the graphene nano-perforation apparatus effective to perforate the graphene at the nonporous growth substrate by one or more of: electron beam etching, ion beam etching, atomic abstraction, colloidal lithography, block copolymer lithography, or photolithography.

In several examples of the computer-readable storage media, instructions may be included to control the graphene nano-perforation apparatus effective to perforate the graphene with a plurality of pores characterized by an average diameter in a range from about 2 angstroms to about 1 micrometer. Instructions may also be included to control the sample manipulator effective to transfer the nanoporous graphene layer from the nonporous growth substrate to the nonporous support substrate. Instructions may further be included to control the selective membrane deposition apparatus effective to deposit the first selective membrane by one or more of: solution deposition, electro-deposition, spin coating, dip coating, chemical growth deposition, polymerization, precipitation, chemical vapor deposition, atomic layer deposition, sputtering, or evaporative deposition. Instructions may additionally be included to control the selective membrane deposition apparatus effective to deposit the first selective membrane as one or more of: a polymer, a zeolite, a metal, a metal-organic framework, or a ceramic. Instructions may also be included to control the selective membrane deposition apparatus effective to deposit the first selective membrane in an average thickness in a range from about 10 nanometers to about 1 micrometer. Instructions may also be included to control the polymer film manipulator effective to contact a second selective membrane to the first selective membrane, wherein at least one of the first selective membrane and the second selective membrane may be characterized by an average thickness of less than about 1 micrometer.

The term “substantially”, as used herein, will be understood by persons of ordinary skill in the art and will vary to some extent depending upon the context in which it is used. If there are uses of the term which are not clear to persons of ordinary skill in the art, given the context in which it is used, may mean up to plus or minus 10% of the particular term, or within plus or minus 10% of the particular parameter.

The terms “a” and “an” as used herein mean “one or more” unless the singular is expressly specified. For example, reference to “a base” may include a mixture of two or more bases, as well as a single base.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to, plus or minus 10% of the particular term.

As used herein, the terms “optional” and “optionally” mean that the subsequently described circumstance may or may not occur, so that the description includes instances where the circumstance occurs and instances where it does not.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

A typical manufacturing system may be implemented utilizing any suitable commercially available components, such as those typically found in data computing/communication and/or network computing/communication systems. The herein described subject matter sometimes illustrates different components contained within, or coupled together with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth. While various aspects and embodiments have been disclosed herein, other aspects and embodiments will be apparent to those skilled in the art.

The various aspects and embodiments disclosed herein are for purposes of illustration and are not intended to be limiting, with the true scope and spirit being indicated by the following claims.

1. A composite membrane, comprising:
a nanoporous graphene layer that includes a first side and a second side, wherein the nanoporous graphene layer comprises a plurality of pores with an average diameter in a range between approximately 2 angstroms and approximately 1 micrometer;
a first selective membrane configured in contact with the first side of the nanoporous graphene layer;
a second selective membrane configured in contact with the first selective membrane, wherein at least one of the first selective membrane and the second selective membrane has an average thickness of less than approximately 1 micrometer; and
a porous support substrate configured in contact with the second side of the nanoporous graphene layer.

2. The composite membrane of claim 1, wherein the first selective membrane comprises one or more of: a polymer, a zeolite, a metal, a metal-organic framework, or a ceramic.

3. The composite membrane of claim 2, wherein the first selective membrane comprises one or more of: an acrylonitrile-butadiene-styrene, an allyl resin, a carbon fiber, a cellulosic resin, an epoxy, a polyalkylene vinyl alcohol, a fluoropolymer, a melamine formaldehyde resin, a phenol-formaldehyde resin, a polyacetal, a polyacrylate, a polyacrylonitrile, a polyacrylonitrile, a polyalkylene, a polyalkylene carbamate, a polyalkylene oxide, a polyalkylene sulphide, a polyalkylene terephthalate, a polyalkyl alkylacrylate, a polyalkyleneamide, a halopolyalkylene, a polyamide, a polyamide-imide, a polyarylene isophthalamide, a polyarylene oxide, a polyarylene sulfide, a polyaramide, a polyarylene terephthalamide, a polyaryletherketone, a polycarbonate, a polybutadiene, a polyketone, a polyester, a polyetheretherketone, a polyetherimide, a polyethersulfone, a polyimide, a polyphthalamide, a polystyrene, a polysulfone, a polytetrafluoroalkylene, a polyurethane, a polyvinyl alkyl ether, a polyvinylhalide, a polyvinylidene halide, a silicone polymer, or a combination or a copolymer thereof.

4. The composite membrane of claim 1, wherein the first selective membrane has an average thickness in a range between about 10 nanometers to less than approximately 1 micrometer.

5. (canceled)

6. The composite membrane of claim 1, wherein the porous support substrate comprises a plurality of pores with an average diameter in a range between about 1 micrometer and about 1 millimeter.

7. The composite membrane of claim 1, wherein the nanoporous graphene layer includes a nanoporous graphene monolayer. 8. (canceled) 9. (canceled)

10. A method to prepare a composite membrane, comprising:
growing graphene at a nonporous growth substrate;
perforating the graphene to form a nanoporous graphene layer;
transferring the nanoporous graphene layer from the nonporous growth substrate to a nonporous support substrate;
depositing a first selective membrane at a second surface of the nanoporous graphene layer, wherein a first surface of the nanoporous graphene layer is configured in contact with the nonporous support substrate;
removing the nanoporous graphene layer together with the first selective membrane from the nonporous support substrate; and
contacting the second surface of the nanoporous graphene layer to a porous support substrate to form the composite membrane.

11.-14. (canceled)

15. The method of claim 10, wherein the nanoporous graphene layer comprises a nanoporous graphene monolayer.

16. The method of claim 10, wherein the nanoporous graphene layer includes a plurality of pores with an average diameter in a range between about 2 angstroms and about 1 micrometer.

17. The method of claim 10, wherein depositing the first selective membrane includes depositing by one or more of: solution deposition, electro-deposition, spin coating, dip coating, chemical growth deposition, polymerization, precipitation, chemical vapor deposition, atomic layer deposition, sputtering, or evaporative deposition.

18.-19. (canceled)

20. The method of claim 10, wherein depositing the first selective membrane includes depositing in an average thickness in a range between about 10 nanometers and about 1 micrometer.

21. (canceled)

22. The method of claim 10, further comprising selecting the porous support substrate including a plurality of pores with an average diameter in a range between about 1 micrometer and about 1 millimeter.

23. The method of claim 10, further comprising contacting a second selective membrane to the first selective membrane, wherein at least one of the first selective membrane and the second selective membrane has an average thickness of less than about 1 micrometer.

24. A system to manufacture a composite membrane, the system comprising:
a chemical vapor deposition chamber;
a chemical vapor deposition source;
a heater;
a temperature sensor;
a graphene nano-perforation apparatus;
a polymer film manipulator;
a selective membrane deposition apparatus;
a porous support source; and
a controller operatively coupled to one or more of the chemical vapor deposition chamber, the chemical vapor deposition source, the heater, the temperature sensor, the graphene nano-perforation apparatus, the polymer film manipulator, the selective membrane deposition apparatus, and the porous support source, wherein the controller is configured to:
control the chemical vapor deposition source, the temperature sensor, and the heater effective to deposit graphene at a nonporous growth substrate in the chemical vapor deposition chamber;
control the graphene nano-perforation apparatus effective to perforate the graphene at the nonporous growth substrate to form a nanoporous graphene layer;
control the selective membrane deposition apparatus effective to deposit a first selective membrane on a first surface of the nanoporous graphene layer;
control the polymer film manipulator effective to remove the nanoporous graphene layer together with the first selective membrane from a nonporous support substrate;
control the porous support source effective to provide a porous support substrate; and
control the polymer film manipulator effective to contact a second surface of the nanoporous graphene layer to a surface of the porous support substrate to form the composite membrane.

25. The system of claim 24, wherein the controller is further configured to control the polymer film manipulator effective to transfer the nanoporous graphene layer from the nonporous growth substrate to the nonporous support substrate prior to deposition of the first selective membrane on the first surface of the nanoporous graphene layer.

26. The system of claim 24, wherein the graphene nano-perforation apparatus is configured to perforate the graphene by use of one or more of: electron beam etch, ion beam etch, atomic abstraction, colloidal lithography, block copolymer lithography, or photolithography.

27. The system of claim 24, wherein the controller is configured to control the chemical vapor deposition source, the temperature sensor, and the heater to deposit the graphene at the nonporous growth substrate as a graphene monolayer.

28. The system of claim 24, wherein the selective membrane deposition apparatus is configured to deposit the first selective membrane by one or more of: solution deposition, electro-deposition, spin coat, dip coat, chemical growth deposition, polymerization, precipitation, chemical vapor deposition, atomic layer deposition, sputtering, or evaporative deposition.

29. The system of claim 24, wherein the selective membrane deposition apparatus is configured to deposit the first selective membrane in an average thickness in a range between about 10 nanometers and about 1 micrometer.

30. The system of claim 24, wherein the controller is further configured to control the polymer film manipulator to contact a second selective membrane to the first selective membrane.

31.-34. (canceled)
